(19) United States
(12) Patent Application Publication
(10) Pub. No.: US 2024/0298282 A1
(43) Pub. Date: Sep. 5, 2024

(54) METHODS AND SYSTEMS FOR REFERENCE SIGNALING IN WIRELESS NETWORKS

(71) Applicant: ZTE Corporation, Shenzhen (CN)

(72) Inventors: Zhihong QIU, Shenzhen (CN); He HUANG, Shenzhen (CN); Yuan GAO, Shenzhen (CN)

(21) Appl. No.: 18/613,809

(22) Filed: Mar. 22, 2024

Related U.S. Application Data
(63) Continuation of application No. PCT/CN2021/125215, filed on Oct. 21, 2021.

(51) Int. Cl. H04W 56/00

(52) U.S. Cl. CPC H04W 56/0045

(57) ABSTRACT

Methods and systems for techniques for reference signaling in wireless networks are disclosed. In one example aspect, the method includes transmitting, by a wireless device, a timing pre-compensation information to a network node using a signaling layer configured to carry data or control information between the wireless device and the network node.

### CROSS REFERENCE TO RELATED APPLICATIONS

This patent document is a continuation of and claims benefit of priority to International Patent Application No. PCT/CN2021/125215, filed on Oct. 21, 2021. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for reference signaling in wireless networks.

In one aspect, a method for wireless communication is disclosed. The method includes transmitting, by a wireless device, a timing pre-compensation information to a network node using a signaling layer configured to carry data or control information between the wireless device and the network.

In another aspect, a method for wireless communication is disclosed. The method includes receiving, at a network node, a timing pre-compensation information from a wireless device using a signaling layer configured to carry data or control information between the wireless device and the network node, and adjusting a scheduling configuration associated with the wireless device according to the timing pre-compensation information.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIGS. 3A-3D shows examples of random access procedure.

FIG. 4 shows an example of fallback procedure for contention-based random access (CBRA) with 2-step random access (RA) type.

FIG. 5 shows an example timing advance (TA) reporting procedure based on some implementations of the disclosed technology.

FIG. 6 shows an example of TA report command medium access control (MAC) control element (CE) with Ci based on some implementations of the disclosed technology.

FIG. 7 shows an example of TA report command MAC CE with timing advance group (TAG) ID based on some implementations of the disclosed technology.

FIG. 8 shows an example of TA report command MAC CE with TAG i based on some implementations of the disclosed technology.

FIGS. 9A and 9B show examples of TA report MAC CE of a fixed size based on some implementations of the disclosed technology.

FIG. 10 shows an example of TA report MAC CE of a variable size based on some implementations of the disclosed technology.

FIG. 11 shows an example of TA report MAC CE with a type indication based on some implementations of the disclosed technology.

FIG. 12 shows an example of TA report MAC CE with a cell identity based on some implementations of the disclosed technology.

FIG. 13 shows an example of TA report MAC CE with a TAG identity based on some implementations of the disclosed technology.

FIGS. 14A-14B show some examples of TA report MAC CE based on some implementations of the disclosed technology.

FIG. 15 shows an example of a process for wireless communication based on some example embodiments of the disclosed technology.

FIG. 16 shows another example of a process for wireless communication based on some example embodiments of the disclosed technology.

FIG. 17 shows example mapping rules between LCH and HARQ.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

For cells with extensively large coverage and long propagation delay (e.g., in NTN), UE may perform pre-compensation before initiating random access channel (RACH) or data transmission to the network. In such a case, part of the timing advance can be adjusted by UE, but the adjusted timing advance is not known to NW. Thus, the network (NW) is unable to know or derive the correct timing difference between the UE and the network. Due to lack of information on the pre-compensation value (e.g., UE specific TA) used by UE, it may be difficult for the network (NW) to schedule subsequent transmissions properly.

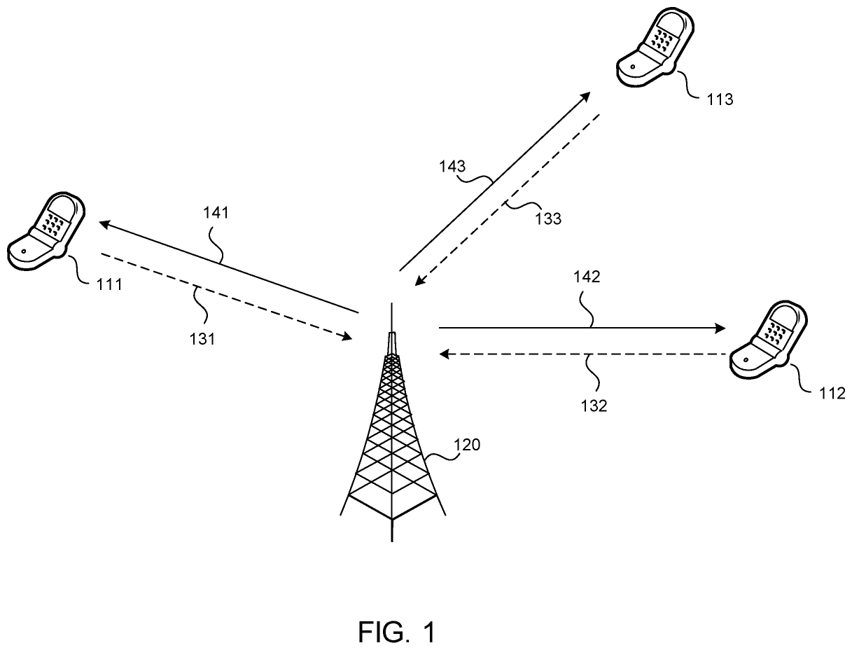

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on. FIG. 1 shows an example of a wireless communication system by way of example only, and thus the disclosed technology is not limited thereto and can be applied to a variety of communication systems.

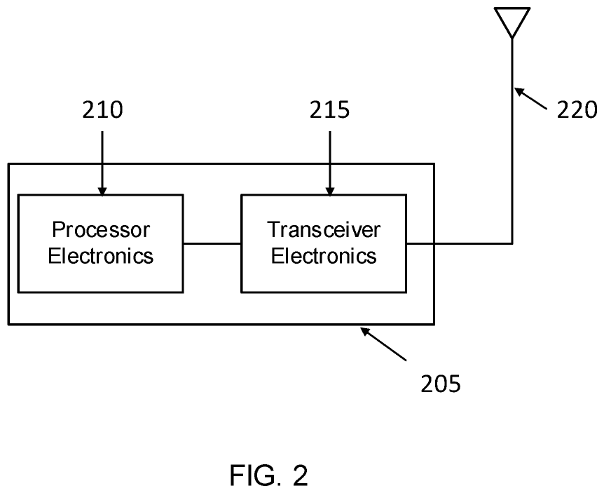

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

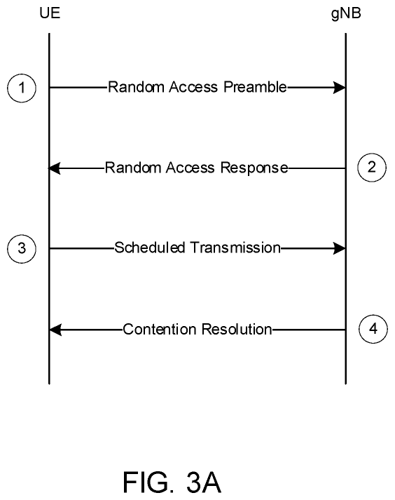

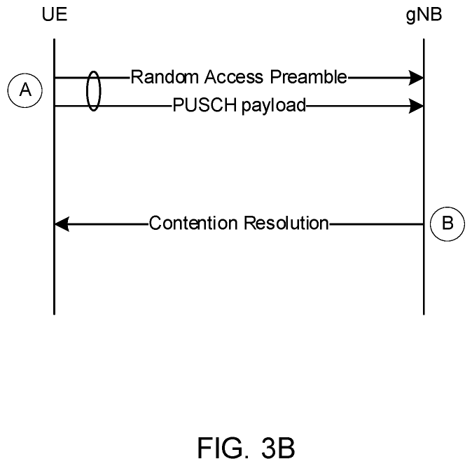

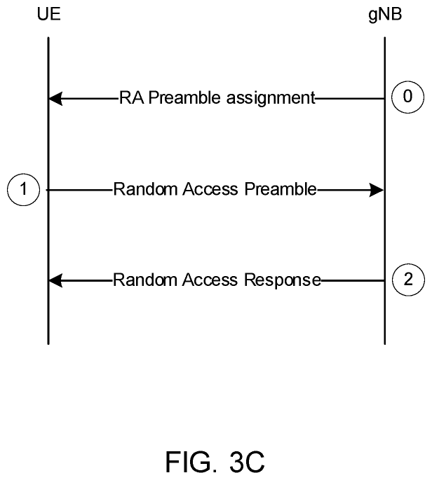

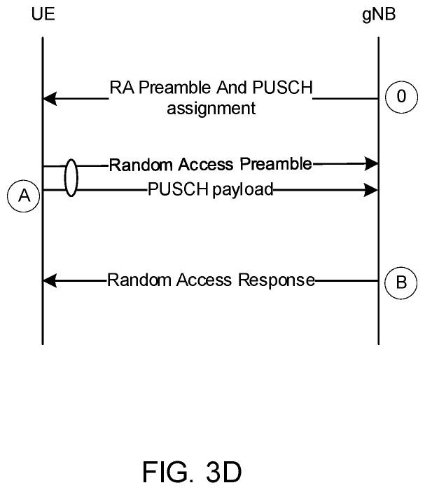

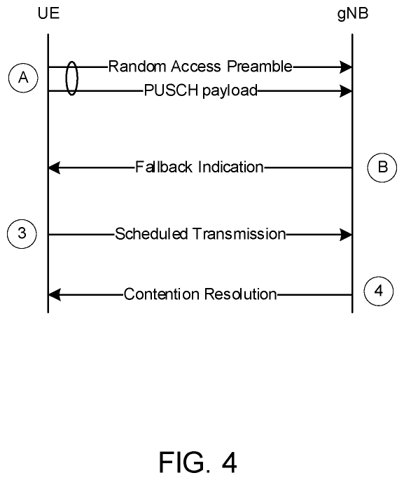

FIGS. 3A-3D shows examples of random access procedure. FIG. 4 shows an example of fallback procedure for contention-based random access (CBRA) with 2-step random access (RA) type.

In some implementations, random access procedures can include 4-step random access (RA) type with MSG1 and 2-step RA type with MSGA, and both types of RA procedures support contention-based random access (CBRA) and contention-free random access (CFRA).

In some implementations, UE selects the type of random access at initiation of the random access procedure based on network configuration: (1) when CFRA resources are not configured, a Reference Signal Received Power (RSRP) threshold is used by the UE to select between 2-step RA type and 4-step RA type; (2) when CFRA resources for 4-step RA type are configured, UE performs random access with 4-step RA type; and (3) when CFRA resources for 2-step RA type are configured, UE performs random access with 2-step RA type.

In some implementation, the network does not configure CFRA resources for 4-step and 2-step RA types at the same time for a Bandwidth Part (BWP). In some implementation, CFRA with 2-step RA type is only supported for handover. It is to be noted that the above mentioned implementations are only implementation examples.

The MSG1 of the 4-step RA type includes a preamble on PRACH. After MSG1 transmission, the UE monitors for a response from the network within a configured window. For CFRA, a dedicated preamble for MSG1 transmission is assigned by the network and upon receiving a random access response from the network, the UE ends the random access procedure as shown in FIG. 3C. For CBRA, upon reception of the random access response, the UE sends MSG3 using the UL grant scheduled in the response and monitors contention resolution as shown in FIG. 3A. If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure as shown in FIG. 3D. For CBRA, if contention resolution is successful upon receiving the network response, the UE ends the random access procedure as shown in FIG. 3B; while if fallback indication is received in MSGB, the UE performs MSG3 transmission using the UL grant scheduled in the fallback indication and monitors contention resolution as shown in FIG. 4. If contention resolution is not successful after MSG3 (re)transmission(s), the UE goes back to MSGA transmission.

If the random access procedure with 2-step RA type is not completed after a number of MSGA transmissions, the UE can be configured to switch to CBRA with 4-step RA type.

For the procedure discussed above, UE calculates a timing advance (TA) based on its estimated TA and the network (NW) indicated TA related parameters and applies this TA when transmitting first message of RACH (e.g., Msg1 or MsgA). To assist a subsequent scheduling, UE may be configured to report pre-compensation information in MsgB, in Msg3 or Msg5.

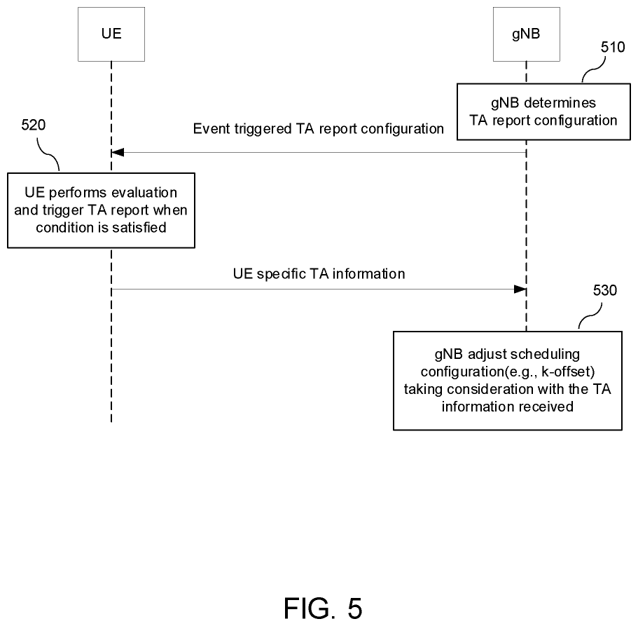

FIG. 5 shows an example timing advance (TA) reporting procedure based on some implementations of the disclosed technology.

A network node (NW), at 510, determines one or more configurations to be used by UE to perform TA report and transmits the configurations to UE. If the TA report associated with the configurations is an event trigger based TA report, the configurations can be at least one of the following: (1) triggering events, which are the conditions UE will evaluate to determine whether to trigger TA report (e.g., the events and/or other conditions discussed in this patent document); (2) reporting intervals; (3) a validity time of the configuration; (4) a value as the initial TA to be compared with in the event. In some examples, the initial value can be set as zero; or (5) report amount, which indicates the number of measurement reports applicable for event triggered reports as well as for periodical reports. In some examples, reportAmount can be ENUMERATED {r1, r2, r4, r8, r16, r32, r64, infinity}, where “1” indicates only one report needs to be sent, “2” indicate two report can be sent and so on, and “infinity” indicates there is no limitation on the number of measurement reports applicable for the report type configured.

The UE, at 520, receives the configurations/conditions and performs the evaluation of the received conditions. Once the condition is satisfied, the UE will trigger TA report and transmits TA information (e.g., UE specific TA) to the NW.

The NW, at 530, adjusts, based on the TA information received, together with other considerations, its scheduling configuration (e.g., k-offset). In some implementations, the NW may also adjust the UE's TA or K-offset based on the TA information received.

The configurations can be delivered to the UE via at least one of system information, MAC layer signaling, physical layer signaling or RRC signaling. The UE can transmit TA information based on at least one of PHY layer signaling, MAC layer signaling, or RRC signaling.

For example, NW can transmit the configurations via measurement configurations, and UE transmits a response that includes the TA information via measurement reports.

For example, NW can send the configurations via RRC Reconfiguration message or system information, and UE will respond the TA information using new MAC CE defined or using new or existing RRC messages.

The disclosed technology can be implemented in some embodiments to provide reporting procedure, configuration and signaling associated with pre-compensation information from UE to the network (NW).

### Pre-Compensation Information Report Procedure

The disclosed technology can be implemented in some embodiments to provide pre-compensation information report procedures. In some implementations, the pre-compensation information report procedures may include (1) RACH based TA report, (2) Event triggered TA report, (3) Periodical TA report, (4) network requested TA report, and a combination of two or more of (1)-(4). In other implementations, the pre-compensation information report procedures may include reporting of other information such as UE location information, e.g., using the mechanisms discussed above.

### Event Triggered TA Report

In some implementations, UE can be configured with one or multiple events to trigger TA report. The triggering events can be based on TA related information, location related information, signal strength related information, or a combination thereof. At least one of the following events can be considered.
Alternative 1: Based on differential TA trigger

A threshold can be configured by the network (NW) for UE to trigger pre-compensation information report procedure. In one example, UE will initiate the TA report when the differential TA exceeds a configured threshold. The differential delay can be at least one of the following: (1) a difference between the latest TA estimated by UE and the TA currently being used by UE; (2) a difference between current TA being used by the UE and the last TA reported by the UE; (3) a difference between current used TA and the last TA used before current TA; (4) a difference between the latest TA estimated by UE and the last TA reported by the UE; or (5) a difference between the latest TA estimated by UE and the last TA used estimated by UE before this latest estimated TA.
Alternative 2: Based on location based trigger

A RTT threshold can be configured by the NW. In one example, if the variance of UE-gNB RTT is larger than the thresholds, UE will initiate pre-compensation report procedure. In another example, coordinates of a reference point (RP) can be broadcasted by NW, UE calculates the UE-RP RTT based on its location and the location of RP broadcasted, if the variance of UE-RP RTT is larger than the configured thresholds, UE will initiate pre-compensation report.

Above events can be also used in combination with other events defined in other implementations.

Another issue for event triggered TA report is how to trigger a first report when an event triggered configuration is received or updated.
Alternative 1: MAC initialization

In some implementations, a variable can be defined in MAC layer. In one example, the variable may be UE_SPECIFIC_TA. However, the disclosed technology is not limited thereto, and the variable may include another TA such as UE_REPORTED_TA or UE_DELTA_TA. In the example above, UE_SPECIFIC_TA will be initialized as an initial value each time the event triggered TA report configuration is received and/or updated. In one example, this initial value can be a default value specified in the wireless communication standards, e.g., zero, or the common TA broadcasted by NW. In another example, the initial value can be configured by a higher layer (e.g., RRC layer). In yet another example, the initial value can be set to the current TA applied by UE when receiving the configuration of event triggered TA report. When performing an event triggered TA report, UE compares the current TA used with UE_SPECIFIC_TA, and if the difference is larger than the configured threshold, UE initiate TA report to NW. Alternatively, when performing an event triggered TA report, UE compare the estimated TA with UE_SPECIFIC_TA. After a successful transmission of TA report, UE sets UE_SPECIFIC_TA to the reported TA value. In another example, the UE_SPECIFIC_TA is always set to the latest successfully reported TA after an initialization procedure of UE_SPECIFIC_TA. For the procedures mentioned above, the variable can be released or reset when the configuration of event triggered TA report is released.
Alternative 2: a TA that is reported before another TA reported in RACH procedure is used as the initial TA if available. Otherwise, the current TA is set as the initial TA to be compared with.
Alternative 3: UE always initiates TA report procedure upon reception of configurations for event triggered TA reports, including an update of event triggered TA report configurations.

### NW Requested Pre-Compensation Report

In some implementations, at least one of the following mechanisms can be considered for NW requested pre-compensation report.
Alternative 1: Using MAC CE to command UE to report TA

In a first scheme, NW can trigger UE to report TA by activating a serving. In this case, when NW active a serving cell, e.g., by using SCell activation MAC CE, UE will initiate procedure to report TA.

In a second scheme, a new MAC CE can be used to trigger UE to report TA.

In some implementations, the first scheme and the second scheme can be used together or can be supported simultaneously.

A MAC CE (e.g., TA report Command MAC CE) can be used to command UE to initiate TA report procedure. The MAC CE is identified by a Logical channel ID (e.g., eLCID or LCID). The MAC CE can be transmitted in PDSCH.

In one example, the MAC CE has a fixed size of zero bits. Upon reception of this MAC CE, UE will initiate TA report procedure. For example, if there are UL resource available for usage, UE will generate TA related data and based on LCP procedure to multiplex this data with other data for transmission. Or if there are no UL resource available for usage, UE can trigger SR procedure to request resource for transmission of TA report.

In another example, the MAC CE has a fixed size of x octet, x is an integer. The MAC CE contains at least one of the following fields.
(1) Reserved bits: Reserved bits can be set as zero. Reserved bits san be reserved for future usage.
(2) Timing advance group ID (TAG ID): TAG ID can be used to indicate the identity of requested TAG. Based on TAG ID, UE can know which TAG's pre-compensation information of UE (e.g., UE specific TA) is requested by NW. In some examples, the TAG containing the SpCell has the TAG Identity 0. The length of the field is 2 bits.
(3) Cell ID: Cell ID can be used to indicate the identity of requested cells. Based on Cell ID, UE can know which cell's pre-compensation information of UE is requested by NW.
(4) Granularity information: Based on granularity information, UE can know which granularity is used for pre-compensation information report. Possible granularity can be symbol, slot, millisecond, subframe, frame, time unit specified in the wireless communication standards (e.g., TS 38.211) and etc.
(5) Type information: Based on type information, UE can know which type of content is requested by NW. In an implementation, the type information is one-bit information. In one example, if the type information is set to zero, UE reports TA related information, and if the type information is set to 1, UE reports location information. In another example, in a case that the type information is one-bit information, if the type information is set to 1, UE reports TA related information, and if the type information is set to zero, UE reports location information. In another implementation, two separate type bits are used for TA and location related information report. In one example, if the corresponding type bit is set to 1, then UE will report the corresponding content to NW. In another example, if the corresponding type bit is set to zero, then UE will report the corresponding content to NW.
(6) Cell i field: If there is a Serving Cell configured for the MAC entity with ServCellIndex i as specified in the wireless communication standards such as TS 38.331, this field indicates which of the serving cells associated with the TA shall be reported, and the MAC entity shall ignore the Ci field. The Ci field is set to 1 to indicate that UE shall report the TA related information associated with the Serving Cell with ServCellIndex i. The Ci field is set to 0 to indicate that that UE does not need to report the TA related information associated with the Serving Cell with ServCellIndex i.
(7) TAG i field indicates of which TAG group the TA is associated with shall be reported. The TAG i field is set to 1 to indicate that UE shall report the TA related information associated with the TAG with TAG i. The TAG i field is set to 0 to indicate that that UE does not need to report the TA related information associated with the TAG with TAG i.

The LCID for identifying the MAC CE (e.g., TA report command MAC CE) used for requesting UE to report TA information (e.g., UE specific TA) can have indices and/or code points with values that are selected from the reserved values as shown in Table 1 and Table 2 below:

TABLE 1
Values of LCID for DL-SCH

| Codepoint/ | |
|---|---|
| Index | LCID values |
| 0 | CCCH |
| 1-32 | Identity of the logical channel |
| 33 | Extended logical channel ID field (two-octet eLCID field) |
| 34 | Extended logical channel ID field (one-octet eLCID field) |
| 35-46 | Reserved |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for UE-specific PDSCH |
| 54 | Aperiodic CSI Trigger State Subselection |
| 55 | SP CSI-RS/CSI-IM Resource Set Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

TABLE 2
Values of one-octet eLCID for DL-SCH

| Codepoint | Index | LCID values |
|---|---|---|
| 0 to 244 | 64 to 308 | Reserved |
| 245 | 309 | Serving Cell Set based SRS Spatial Relation |
| | | Indication |
| 246 | 310 | PUSCH Pathloss Reference RS Update |
| 247 | 311 | SRS Pathloss Reference RS Update |
| 248 | 312 | Enhanced SP/AP SRS Spatial Relation Indication |
| 249 | 313 | Enhanced PUCCH Spatial Relation Activation/ |
| | | Deactivation |
| 250 | 314 | Enhanced TCI States Activation/Deactivation for |
| | | UE-specific PDSCH |
| 251 | 315 | Duplication RLC Activation/Deactivation |
| 252 | 316 | Absolute Timing Advance Command |
| 253 | 317 | SP Positioning SRS Activation/Deactivation |
| 254 | 318 | Provided Guard Symbols |
| 255 | 319 | Timing Delta |

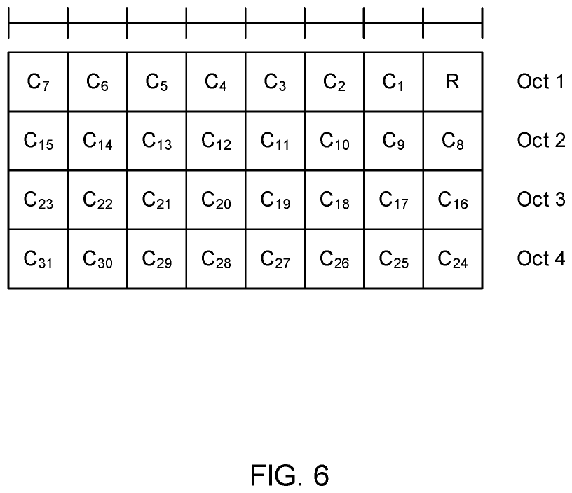

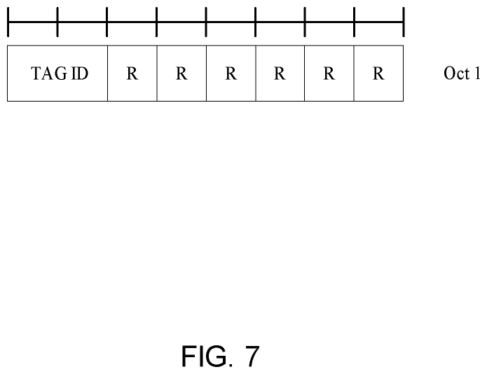

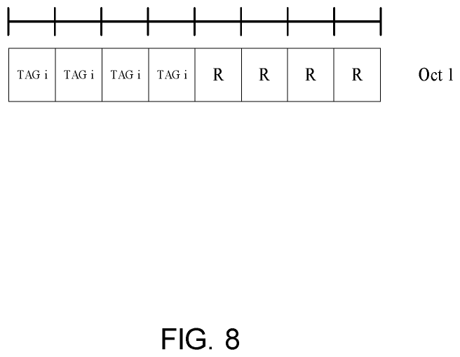

FIG. 6 shows an example of TA report command MAC CE with Ci discussed above. FIG. 7 shows an example of TA report command MAC CE with TAG ID discussed above. FIG. 8 shows an example of TA report command MAC CE with TAG i discussed above. FIGS. 6-8 show locations and lengths of the fields of TA report command MAC CE by way of example only, and thus the disclosed technology is not limited thereto and can be implemented in some embodiments to provide a variety of locations and lengths.
Alternative 2: DCI based (applicable for either RRC or MAC CE based TA report)

In an implementation, NW can initiate TA report by PDCCH ordering. In one example, if NW signal via system information indicates that TA report is applicable, then, whenever NW uses PDCCH order to trigger UE to initiate RACH, UE will report the pre-compensation information through RACH procedure, e.g., by including the information in Msg3/Msg5 of 4-stepRA or by including the information in MsgA payload part of 2stepRACH, or subsequent message after RACH. In another example, a preamble can be reserved for NW to initiate TA report via RACH, and the preamble ID can be pre-defined or configured by NW. Once UE receives PDCCH order indicating a preamble with the preamble ID that matches the preamble reserved for pre-compensation report, UE can know that NW requests it to report pre-compensation related information in RACH procedure.

In another implementation, DCI based pre-compensation report can be used. In one example, one bit indication can be included in DCI to indicate whether pre-compensation information report is requested by NW. In one example, the indication that is set to 1 can indicate UE shall initiate TA report using the grant given in the DCI, and the indication that is set to zero indicates there is no need to report TA. In another example, the indication that is set to zero can indicate UE shall initiate TA report using the grant given in the DCI, and the indication that is set to 1 indicates there is no need to report TA. In another implementation, the presence of one-bit indication can be used to request UE to report pre-compensation information.

In some implementations, the above mentioned indication can be included in DCI-0-0, DCI 0-1 DCI 0-2 or other DCI formats.

In yet another implementation, NW can use RRC based configuration and RRC signaling to request UE to report pre-compensation information.

In one example, NW can include pre-compensation related configuration (e.g., reportTA configuration) in OtherConfiguration.

In another example, NW can include the pre-compensation related configuration in measurement object configuration. Whenever UE receives a MO containing pre-compensation information report related configuration (e.g., reportTA configuration), UE will be based on the configuration to initiate pre-compensation report, e.g., by including in the measurement reports the pre-compensation information as requested in the measurement configuration.

### Pre-Compensation Information Content

Pre-compensation information can be: TA related information; location related information; or any other information that might be used by UE to perform a pre-compensation when accessing or communicating with NW.

Location information can be at least one of the following: GNSS information, bluetooth information, sensor information, WLAN information or A-GNSS information or other information can be used for deriving UE position (e.g., UE Footprint).

The following TA related information can be considered as pre-compensation information and be reported from UE to NW:
Alternative 1: Full TA, which equals to UE estimated TA+NW adjusted TA; or the current TA applied by UE or the applied TA for UL transmission as defined in the UE's TA formula: T_{TA}=(N_{TA}+N_{TA,UE-specific}+N_{TA,common}+N_{TA,offset})×T_{c} as specified in 3GPP standards.
Alternative 2: UE estimated TA

The TA estimated by UE, which is also a part of UE's TA. In some examples, UE estimates the TA based on its GNSS module. In some examples, the TA reflects the service link delay between UE and the satellite.
Alternative 3: Delta TA

In some examples, delta TA (or differential TA) can be a difference between the latest TA estimated by UE and the TA currently being used by UE, or a difference between current TA being used by the UE and the last TA reported by the UE, or a difference between the currently used TA and the last TA used before the current TA, or a difference between the latest TA estimated by UE and the last TA reported by the UE, or a difference between the latest TA estimated by UE and the last TA estimated by UE before this latest estimated TA.

In some examples, a combination of above alternatives can be used for pre-compensation information report (e.g., TA report). For example, Full TA can be reported by UE in a first report, and delta TA is reported in the following report. The reporting method mentioned in this example can be applied in an event triggered TA report or TA report via RACH or TA report requested by NW, or a combination of the above mentioned report mechanisms. For example, for a first report triggered in an event triggered report, full TA is reported, and for subsequent triggered TA reports, delta TA is reported.

### Pre-Compensation Information Report Granularity

If report information is timing advance related information, the following granularity can be considered for reporting:
Alternative 1: TA is reported using the same granularity as specified for Timing Advance Command MAC CE in the wireless communication standards such as 3GPP standards.
Alternative 2: Only x most significant bits of TA is reported.
Alternative 3: TA is reported using units at ms.
Alternative 4: TA is reported using units at slot level.
Alternative 5: TA is reported using units at subframe level.
Alternative 6: TA is reported using units at frame level.
Alternative 7: TA is reported using units at symbol level.

Above mentioned TA can be a full TA, or UE estimated TA (e.g., service link TA), delta TA as describe above, or it can be another TA (e.g., UE specific TA) specified in standardization protocols, e.g., in 3GPP protocols.

If location information is reported, it can be reported using the granularity and content as defined in positioning protocols. In another example, the location with a lower resolution (e.g., one central point with a radius) can be considered for location reporting.

### Signaling for Carrying Pre-Compensation Information

Pre-compensation information can be reported based on MAC layer signaling (e.g., by MAC CE) and/or RRC signaling.

In one example, MAC CE signaling can be used to carry pre-compensation information (e.g., UE specific TA). In another example, only RRC signaling can be used to carry pre-compensation information. In another example, MAC CE and RRC message can be used together to carry pre-compensation information. In another example, for TA reported via RACH procedure, MAC CE can be used, and for event-triggered TA report, RRC message will be used. In another example, different signaling method wills can be used depending on the content of pre-compensation information, e.g., MAC CE is used if TA is reported and RRC is used if location information is reported. In another example, MAC CE is used if delta TA is reported, and RRC signaling is used if full TA is reported. In another example, for a first report triggered in event triggered report, full TA is reported using RRC signaling, and for a subsequent triggered TA report, delta TA is reported using MAC CE. The report methods mentioned in these examples can be applied to TA report via RACH or TA report requested by NW, or a combination of the above mentioned report mechanisms.

The MAC CE can have a priority right below C-RNTI MAC CE or UL-CCCH data in a logical channel prioritization procedure.

### MAC CE Design

In some implementations, different formats can be considered for MAC CE design depending on the granularity and detailed content of pre-compensation information to be reported.

Each type of MAC CE can be identified with a logical channel ID (e.g., LCID or eLCID as defined in the wireless communication standards). The MAC CE can be transmitted in PUSCH. The MAC CE is octet aligned.
Alternative 1: fixed sized MAC CE can be used

In one example, only one MAC CE will be defined for pre-compensation information reporting. In another example, multiple types of MAC CE can be defined, and based on NW configuration, NW type or different values to be reported, UE decides which MAC CE will be used. For example, two fixed sized MAC CEs (e.g., long and short TA report MAC CE) with x octets and y octets can be used, where x and y are an integer with different values. MAC CE with longer length can be used in GEO scenarios while MAC CEs with a shorter length will be used for LEO scenario.
Alternative 2: variable sized MAC CE can be used
Alternative 3: Combination of Alternative 1 and Alternative 2 can be used.

When different types of MAC CEs are defined, they can be identified by different LCIDs or based on the fields included in the content.

The possible values for index and/or code point of LCID can be the reserved range as shown in Table 3 and Table 4 below.

TABLE 3
Values of LCID for UL-SCH

| Codepoint/ | |
|---|---|
| Index | LCID values |
| 0 | CCCH of size 64 bits (referred to as “CCCH1” in TS |
| | 38.331 [5]) |
| 1-32 | Identity of the logical channel |
| 33 | Extended logical channel ID field (two-octet eLCID field) |
| 34 | Extended logical channel ID field (one-octet eLCID field) |
| 35-44 | Reserved |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” in TS |
| | 38.331 [5]) |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

TABLE 4
Values of one-octet eLCID for UL-SCH

| Codepoint | Index | LCID values |
|---|---|---|
| 0 to 249 | 64 to 313 | Reserved |
| 250 | 314 | BFR (four octets Cᵢ) |
| 251 | 315 | Truncated BFR (four octets Cᵢ) |
| 252 | 316 | Multiple Entry Configured Grant Confirmation |
| 253 | 317 | Sidelink Configured Grant Confirmation |
| 254 | 318 | Desired Guard Symbols |
| 255 | 319 | Pre-emptive BSR |

If TA is reported, MAC CE can include one or more of the following fields.
(1) UE specific TA: UE specific TA indicates the values of TA to be reported by UE, and it can include information as discussed above (e.g., delta TA, Full TA and etc.), and its granularity can be the same as the examples discussed above (e.g., slot, ms and etc.).
(2) Length: the length here indicates the length of MAC CEs.
(3) Reserved bits: reserved bits can be set as zero, and can be reserved for future use.
(4) TA group ID (TAG ID): TAG ID indicates the identity of the TAG, where the reported pre-compensation information is used. In some examples, the TAG containing the SpCell has the TAG Identity 0. The length of the field is 2 bits.
(5) Cell ID: Cell ID indicates the identity of the cell, where the reported pre-compensation information is used. In some examples, this field indicates ServCellIndex as specified in TS 38.331.
(6) Type indication: the “type” here indicates the type of MAC CE. In one example, the type set to 1 indicates it is a variable sized MAC CE, and the length field will indicate the length of the TA to be reported, and the type set to 0 indicates it is a fixed sized MAC CE, and the length field will be set as “Reserved,” which indicates NW will ignore this field. In another example, the type set to 0 indicates it is a variable sized MAC CE, and the length field will indicate the length of the TA to be reported, and the type set to 1 indicates it is a fixed sized MAC CE, and the length field will be set as “Reserved,” which indicates NW will ignore this field.

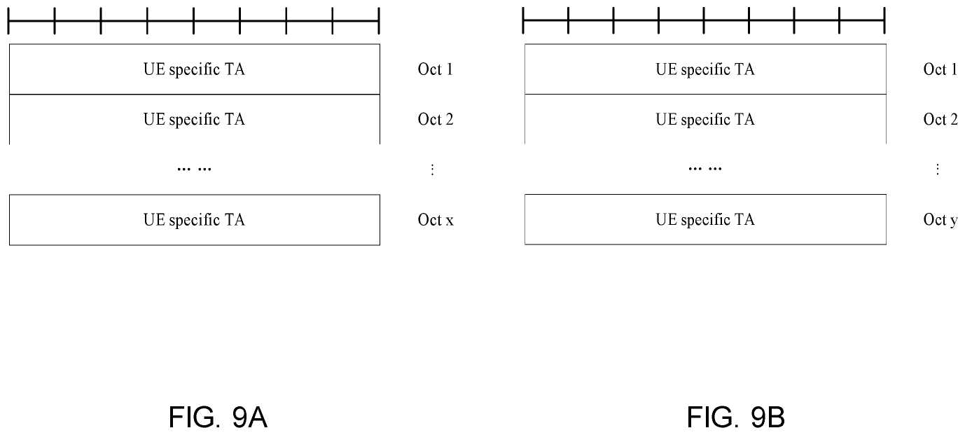

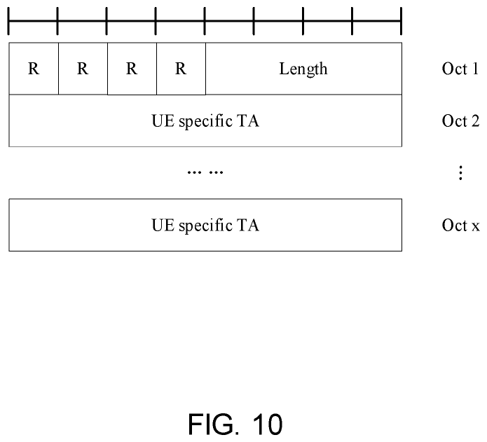

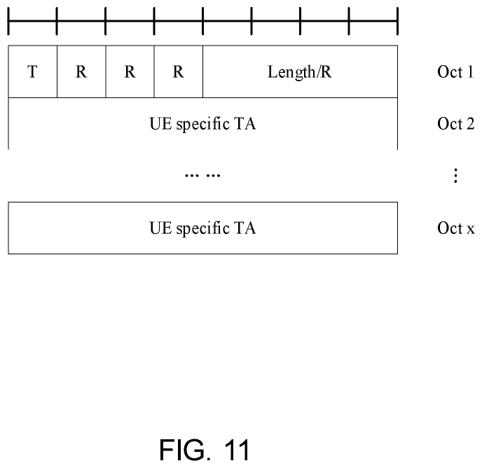

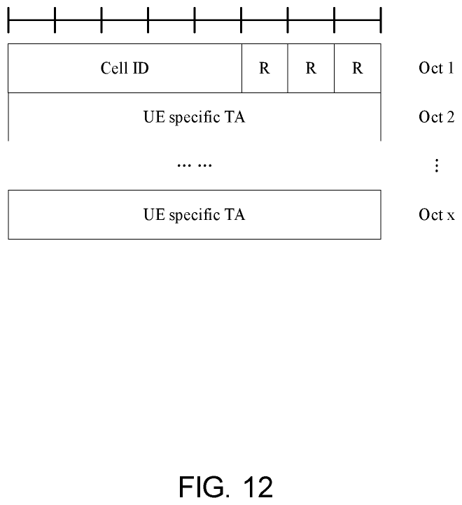

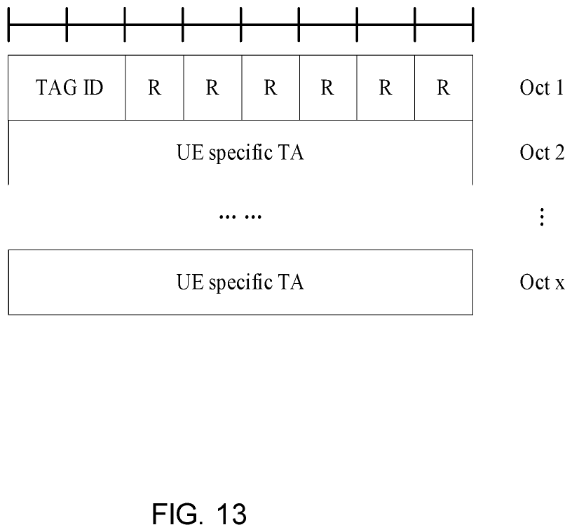

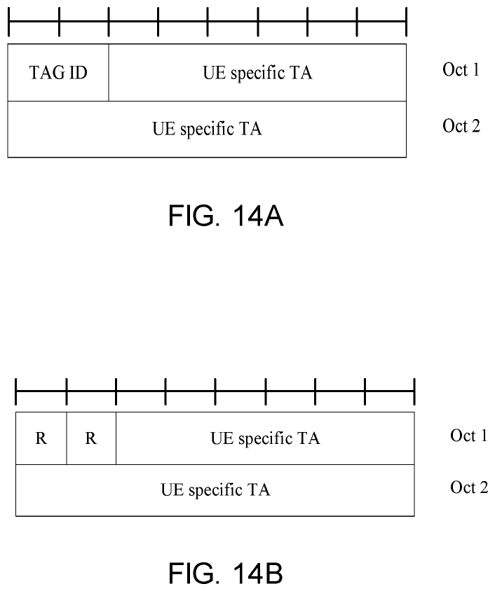

FIGS. 9A and 9B show examples of TA report MAC CE of a fixed size of x, y octets, where x and y are an integer. FIG. 10 shows an example of TA report MAC CE of a variable size, where x is an integer. In some implementations, length is used to indicate the size of the UE specific TA information to be reported. R is reserved bit which is set as zero. FIG. 11 shows an example of TA report MAC CE with a type indication. FIG. 12 shows an example of TA report MAC CE with a cell identity. FIG. 13 shows an example of TA report MAC CE with a TAG identity. FIGS. 14A-14B show some examples of TA report MAC CE. FIGS. 9A-14B show locations and lengths of the fields of TA report MAC CE by way of example only, and thus the disclosed technology is not limited thereto and can be implemented in some embodiments to provide a variety of locations and lengths.

### RRC Message Design

In an implementation, a new RRC message can be defined or existing RRC message (e.g., CCCH/CCCH1 message that might be transmitted during RACH) can be used to carry the reported pre-compensation information.

In another implementation, the pre-compensation information can be reported in measurement reports. In addition, the configuration for pre-compensation information reports (e.g., UE specific TA report) can be configured in the configuration for reporting, e.g., ReportConfigNR.

### ReportConfigNR

The IE ReportConfigNR specifies criteria for triggering an NR measurement reporting event, a CHO event, CPC event, or TA report event.

For event T1, a measurement reporting event is based on Timing Advance values, which can be the TA value discussed in this patent document. Here, the event T1 indicates a difference of TA becomes higher than an absolute threshold.

TABLE 5
ReportConfigNR information element

-- ASN1START
-- TAG-REPORTCONFIGNR-START

| | |
|---|---|
| ReportConfigNR ::= | SEQUENCE { |
| reportType | CHOICE { |
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig-r16, |
| cli-EventTriggered-r16 | CLI-EventTriggerConfig-r16, |

[[

| | |
|---|---|
| ue-SpecificTAReport-r17 | UE-SpecificTAReport-r17 |

]]
}
}

| | |
|---|---|
| ReportCGI ::= | SEQUENCE { |
| cellForWhichToReportCGI | PhysCellId, |

```
    ...,
  [[
```

| | |
|---|---|
| useAutonomousGaps-r16 | ENUMERATED {setup} OPTIONAL -- Need R |

]]
}

| | |
|---|---|
| ReportSFTD-NR ::= | SEQUENCE { |
| reportSFTD-Meas | BOOLEAN, |
| reportRSRP | BOOLEAN, |

```
  ...,
  [[
```

| | |
|---|---|
| reportSFTD-NeighMeas | ENUMERATED {true} OPTIONAL, |

-- Need R

| | |
|---|---|
| drx-SFTD-NeighMeas | ENUMERATED {true} OPTIONAL, |

-- Need R

| | |
|---|---|
| cellsForWhichToReportSFTD | SEQUENCE (SIZE (1..maxCellSFTD)) OF PhysCellId OPTIONAL |

-- Need R
]]
}

| | |
|---|---|
| CondTriggerConfig-r16 ::= | SEQUENCE { |
| condEventId | CHOICE { |
| condEventA3 | SEQUENCE { |
| a3-Offset | MeasTriggerQuantityOffset, |
| hysteresis | Hysteresis, |
| timeToTrigger | TimeToTrigger |

},

| | |
|---|---|
| condEventA5 | SEQUENCE { |
| a5-Threshold1 | MeasTriggerQuantity, |
| a5-Threshold2 | MeasTriggerQuantity, |
| hysteresis | Hysteresis, |
| timeToTrigger | TimeToTrigger |

```
    },
    ...
  },
```

| | |
|---|---|
| rsType-r16 | NR-RS-Type, |

...
}

| | |
|---|---|
| EventTriggerConfig ::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useWhiteCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useWhiteCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useWhiteCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useWhiteCellList | BOOLEAN |

```
    },
    ...
  },
```

| | |
|---|---|
| rsType | NR-RS-Type, |
| reportInterval | ReportInterval, |
| reportAmount | ENUMERATED {r1, r2, r4, r8, r16, r32, r64, infinity}, |
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER (1..maxNrofIndexesToReport) |

OPTIONAL, -- Need R

| | |
|---|---|
| includeBeamMeasurements | BOOLEAN, |
| reportAddNeighMeas | ENUMERATED {setup} |

```
OPTIONAL, -- Need R
  ...,
  [[
```

| | |
|---|---|
| measRSSI-ReportConfig-r16 | MeasRSSI-ReportConfig-r16 |

OPTIONAL, -- Need R

| | |
|---|---|
| useT312-r16 | BOOLEAN |

OPTIONAL, -- Need M

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList-r16} |

OPTIONAL -- Need M
]]
}

| | |
|---|---|
| PeriodicalReportConfig ::= | SEQUENCE { |
| rsType | NR-RS-Type, |
| reportInterval | ReportInterval, |
| reportAmount | ENUMERATED {r1, r2, r4, r8, r16, r32, r64, infinity}, |
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER (1..maxNrofIndexesToReport) |

OPTIONAL, -- Need R

| | |
|---|---|
| includeBeamMeasurements | BOOLEAN, |
| useWhiteCellList | BOOLEAN, |

```
  ...,
  [[
```

| | |
|---|---|
| measRSSI-ReportConfig-r16 | MeasRSSI-ReportConfig-r16 |

OPTIONAL, -- Need R

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList-r16} |

OPTIONAL, -- Need M

| | |
|---|---|
| ul-DelayValueConfig-r16 | SetupRelease { UL-DelayValueConfig-r16 } |

OPTIONAL, -- Need M

| | |
|---|---|
| reportAddNeighMeas-r16 | ENUMERATED {setup} |

OPTIONAL -- Need R
]]
}

| | |
|---|---|
| NR-RS-Type ::= | ENUMERATED {ssb, csi-rs} |
| MeasTriggerQuantity ::= | CHOICE { |
| rsrp | RSRP-Range, |
| rsrq | RSRQ-Range, |
| sinr | SINR-Range |

}

| | |
|---|---|
| MeasTriggerQuantityOffset ::= | CHOICE { |
| rsrp | INTEGER (−30..30), |
| rsrq | INTEGER (−30..30), |
| sinr | INTEGER (−30..30) |

}

| | |
|---|---|
| MeasReportQuantity ::= | SEQUENCE { |
| rsrp | BOOLEAN, |
| rsrq | BOOLEAN, |
| sinr | BOOLEAN |

}

| | |
|---|---|
| MeasRSSI-ReportConfig-r16 ::= | SEQUENCE { |
| channelOccupancyThreshold-r16 | RSSI-Range-r16 OPTIONAL -- Need R |

}

| | |
|---|---|
| CLI-EventTriggerConfig-r16 ::= | SEQUENCE { |
| eventId-r16 | CHOICE { |
| eventI1-r16 | SEQUENCE { |
| i1-Threshold-r16 | MeasTriggerQuantityCLI-r16, |
| reportOnLeave-r16 | BOOLEAN, |
| hysteresis-r16 | Hysteresis, |
| timeToTrigger-r16 | TimeToTrigger |

```
    },
  ...
  },
```

| | |
|---|---|
| reportInterval-r16 | ReportInterval, |
| reportAmount-r16 | ENUMERATED {r1, r2, r4, r8, r16, r32, r64, infinity}, |
| maxReportCLI-r16 | INTEGER (1..maxCLI-Report-r16), |

...
}

| | |
|---|---|
| CLI-PeriodicalReportConfig-r16 ::= | SEQUENCE { |
| reportInterval-r16 | ReportInterval, |
| reportAmount-r16 | ENUMERATED {r1, r2, r4, r8, r16, r32, r64, infinity}, |
| reportQuantityCLI-r16 | MeasReportQuantityCLI-r16, |
| maxReportCLI-r16 | INTEGER (1..maxCLI-Report-r16), |

...
}

| | |
|---|---|
| MeasTriggerQuantityCLI-r16 ::= | CHOICE { |
| srs-RSRP-r16 | SRS-RSRP-Range-r16, |
| cli-RSSI-r16 | CLI-RSSI-Range-r16 |

}

| | |
|---|---|
| MeasReportQuantityCLI-r16 ::= | ENUMERATED {srs-rsrp, cli-rssi} |
| UE-SpecificTAReport-r17 ::= | SEQUENCE { |
| eventId-r17 | CHOICE { |
| eventT1-r17 | SEQUENCE { |
| t1-Threshold | INTEGER (1..x ) |

```
...
    },
  ...
  },
}
-- TAG-REPORTCONFIGNR-STOP
-- ASN1STOP
```

TABLE 6
UE-SpecificTAReport field descriptions

t1-Threshold
Offset value(s) to be used in event triggered TA report.

### Implementation Example: Measurement Report Based

The IE MeasResults covers measured results for intra-frequency, inter-frequency, inter-RAT mobility and measured results for sidelink.

TABLE 7
MeasResults information element

-- ASN1START
-- TAG-MEASRESULTS-START

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA, |
| measResultListUTRA-FDD-r16 | MeasResultListUTRA-FDD-r16 |

```
  }
OPTIONAL,
  ...,
  [[
```

| | |
|---|---|
| measResultServFreqListEUTRA-SCG | MeasResultServFreqListEUTRA-SCG |

OPTIONAL,

| | |
|---|---|
| measResultServFreqListNR-SCG | MeasResultServFreqListNR-SCG |

OPTIONAL,

| | |
|---|---|
| measResultSFTD-EUTRA | MeasResultSFTD-EUTRA |

OPTIONAL,

| | |
|---|---|
| measResultSFTD-NR | MeasResultCellSFTD-NR |

```
OPTIONAL
    ]],
    [[
```

| | |
|---|---|
| measResultCellListSFTD-NR | MeasResultCellListSFTD-NR |

```
OPTIONAL
  ]],
  [[
```

| | |
|---|---|
| measResultForRSSI-r16 | MeasResultForRSSI-r16 |

OPTIONAL,

| | |
|---|---|
| locationInfo-r16 | LocationInfo-r16 |

OPTIONAL,

| | |
|---|---|
| ul-PDCP-DelayValueResultList-r16 | UL-PDCP-DelayValueResultList-r16 |

OPTIONAL,

| | |
|---|---|
| measResultsSL-r16 | MeasResultsSL-r16 |

OPTIONAL,

| | |
|---|---|
| measResultCLI-r16 | MeasResultCLI-r16 |

```
OPTIONAL
  ]],
  [[
```

| | |
|---|---|
| ueSpecificTA-r17 | UESpecificTA-r17 |

OPTIONAL
]]
}

| | |
|---|---|
| MeasResultServMOList ::= | SEQUENCE (SIZE (1..maxNrofServingCells)) OF MeasResultServMO |
| MeasResultServMO ::= | SEQUENCE { |
| servCellId | ServCellIndex, |
| measResultServingCell | MeasResultNR, |
| measResultBestNeighCell | MeasResultNR |

OPTIONAL,
...
}

| | |
|---|---|
| MeasResultListNR ::= | SEQUENCE (SIZE (1..maxCellReport)) OF MeasResultNR |
| MeasResultNR ::= | SEQUENCE { |
| physCellId | PhysCellId |

OPTIONAL,

| | |
|---|---|
| measResult | SEQUENCE { |
| cellResults | SEQUENCE{ |
| resultsSSB-Cell | MeasQuantityResults |

OPTIONAL,

| | |
|---|---|
| resultsCSI-RS-Cell | MeasQuantityResults |

OPTIONAL
},

| | |
|---|---|
| rsIndexResults | SEQUENCE{ |
| resultsSSB-Indexes | ResultsPerSSB-IndexList |

OPTIONAL,

| | |
|---|---|
| resultsCSI-RS-Indexes | ResultsPerCSI-RS-IndexList |

```
OPTIONAL
    }
OPTIONAL
  },
  ...,
  [[
```

| | |
|---|---|
| cgi-Info | CGI-InfoNR |

OPTIONAL
]]
}

| | |
|---|---|
| MeasResultListEUTRA ::= | SEQUENCE (SIZE (1..maxCellReport)) OF MeasResultEUTRA |
| MeasResultEUTRA ::= | SEQUENCE { |
| eutra-PhysCellId | PhysCellId, |
| measResult | MeasQuantityResultsEUTRA, |
| cgi-Info | CGI-InfoEUTRA |

OPTIONAL,
...
}

| | |
|---|---|
| MultiBandInfoListEUTRA ::= | SEQUENCE (SIZE (1..maxMultiBands)) OF FreqBandIndicatorEUTRA |
| MeasQuantityResults ::= | SEQUENCE { |
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL
}

| | |
|---|---|
| MeasQuantityResultsEUTRA ::= | SEQUENCE { |
| rsrp | RSRP-RangeEUTRA |

OPTIONAL,

| | |
|---|---|
| rsrq | RSRQ-RangeEUTRA |

OPTIONAL,

| | |
|---|---|
| sinr | SINR-RangeEUTRA |

OPTIONAL
}

| | |
|---|---|
| ResultsPerSSB-IndexList::= | SEQUENCE (SIZE (1..maxNrofIndexesToReport2)) OF ResultsPerSSB- |

Index

| | |
|---|---|
| ResultsPerSSB-Index ::= | SEQUENCE { |
| ssb-Index | SSB-Index, |
| ssb-Results | MeasQuantityResults |

OPTIONAL
}

| | |
|---|---|
| ResultsPerCSI-RS-IndexList::= | SEQUENCE (SIZE (1..maxNrofIndexesToReport2)) OF ResultsPerCSI- |

RS-Index

| | |
|---|---|
| ResultsPerCSI-RS-Index ::= | SEQUENCE { |
| csi-RS-Index | CSI-RS-Index, |
| csi-RS-Results | MeasQuantityResults |

OPTIONAL
}
MeasResultServFreqListEUTRA-SCG ::= SEQUENCE (SIZE (1..maxNrofServingCellsEUTRA)) OF
MeasResult2EUTRA
MeasResultServFreqListNR-SCG ::= SEQUENCE (SIZE (1..maxNrofServingCells)) OF MeasResult2NR

| | |
|---|---|
| MeasResultListUTRA-FDD-r16 ::= | SEQUENCE (SIZE (1..maxCellReport)) OF MeasResultUTRA-FDD- |

r16

| | |
|---|---|
| MeasResultUTRA-FDD-r16 ::= | SEQUENCE { |
| physCellId-r16 | PhysCellIdUTRA-FDD-r16, |
| measResult-r16 | SEQUENCE { |
| utra-FDD-RSCP-r16 | INTEGER (−5..91) |

OPTIONAL,

| | |
|---|---|
| utra-FDD-EcN0-r16 | INTEGER (0..49) |

OPTIONAL
}
}

| | |
|---|---|
| MeasResultForRSSI-r16 ::= | SEQUENCE { |
| rssi-Result-r16 | RSSI-Range-r16, |
| channelOccupancy-r16 | INTEGER (0..100) |

}

| | |
|---|---|
| MeasResultCLI-r16 ::= | SEQUENCE { |
| measResultListSRS-RSRP-r16 | MeasResultListSRS-RSRP-r16 |

OPTIONAL,

| | |
|---|---|
| measResultListCLI-RSSI-r16 | MeasResultListCLI-RSSI-r16 |

OPTIONAL
}

| | |
|---|---|
| MeasResultListSRS-RSRP-r16 ::= | SEQUENCE (SIZE (1..maxCLI-Report-r16)) OF MeasResultSRS-RSRP- |

r16

| | |
|---|---|
| MeasResultSRS-RSRP-r16 ::= | SEQUENCE { |
| srs-ResourceId-r16 | SRS-ResourceId, |
| srs-RSRP-Result-r16 | SRS-RSRP-Range-r16 |

}

| | |
|---|---|
| MeasResultListCLI-RSSI-r16 ::= | SEQUENCE (SIZE (1..maxCLI-Report-r16)) OF MeasResultCLI-RSSI-r16 |
| MeasResultCLI-RSSI-r16 ::= | SEQUENCE { |
| rssi-ResourceId-r16 | RSSI-ResourceId-r16, |
| cli-RSSI-Result-r16 | CLI-RSSI-Range-r16 |

}
UL-PDCP-DelayValueResultList-r16 ::= SEQUENCE (SIZE (1..maxDRB)) OF UL-PDCP-DelayValueResult-
r16
UL-PDCP-DelayValueResult-r16 ::= SEQUENCE {

| | |
|---|---|
| drb-Id-r16 | DRB-Identity, |
| averageDelay-r16 | INTEGER (0..10000), |

...
}

| | |
|---|---|
| UESpecificTA-r17 ::= | INTEGER (0..x ) |

-- TAG-MEASRESULTS-STOP
-- ASN1STOP

In the above example, x is an integer.

TABLE 8
UESpecificTA field descriptions

ueSpecificTAValue
The values of UE specific TA to be reported. It can have values and units
as discussed in above sessions or as specified in the wireless
communication standards.

### Implementation Example: Measurement Report Based

The IE MeasResults covers measured results for intra-frequency, inter-frequency, inter-RAT mobility and measured results for sidelink.

TABLE 9
MeasResults information element

-- ASN1START
-- TAG-MEASRESULTS-START

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA, |
| measResultListUTRA-FDD-r16 | MeasResultListUTRA-FDD-r16 |

```
  }
OPTIONAL,
  ...,
  [[
```

| | |
|---|---|
| measResultServFreqListEUTRA-SCG | MeasResultServFreqListEUTRA-SCG |

OPTIONAL,

| | |
|---|---|
| measResultServFreqListNR-SCG | MeasResultServFreqListNR-SCG |

OPTIONAL,

| | |
|---|---|
| measResultSFTD-EUTRA | MeasResultSFTD-EUTRA |

OPTIONAL,

| | |
|---|---|
| measResultSFTD-NR | MeasResultCellSFTD-NR |

```
OPTIONAL
  ]],
  [[
```

| | |
|---|---|
| measResultCellListSFTD-NR | MeasResultCellListSFTD-NR |

```
OPTIONAL
  ]],
  [[
```

| | |
|---|---|
| measResultForRSSI-r16 | MeasResultForRSSI-r16 |

OPTIONAL,

| | |
|---|---|
| locationInfo-r16 | LocationInfo-r16 |

OPTIONAL,

| | |
|---|---|
| ul-PDCP-DelayValueResultList-r16 | UL-PDCP-DelayValueResultList-r16 |

OPTIONAL,

| | |
|---|---|
| measResultsSL-r16 | MeasResultsSL-r16 |

OPTIONAL,

| | |
|---|---|
| measResultCLI-r16 | MeasResultCLI-r16 |

```
OPTIONAL
  ]],
  [[
```

| | |
|---|---|
| UeSpecificTA-r17 | UESpecificTA-r17 OPTIONAL |

]]
}

| | |
|---|---|
| MeasResultServMOList ::= | SEQUENCE (SIZE (1..maxNrofServingCells)) OF MeasResultServMO |
| MeasResultServMO ::= | SEQUENCE { |
| servCellId | ServCellIndex, |
| measResultServingCell | MeasResultNR, |
| measResultBestNeighCell | MeasResultNR |

OPTIONAL,
...
}

| | |
|---|---|
| MeasResultListNR ::= | SEQUENCE (SIZE (1..maxCellReport)) OF MeasResultNR |
| MeasResultNR ::= | SEQUENCE { |
| physCellId | PhysCellId |

OPTIONAL,

| | |
|---|---|
| measResult | SEQUENCE { |
| cellResults | SEQUENCE{ |
| resultsSSB-Cell | MeasQuantityResults |

OPTIONAL,

| | |
|---|---|
| resultsCSI-RS-Cell | MeasQuantityResults |

OPTIONAL
},

| | |
|---|---|
| rsIndexResults | SEQUENCE{ |
| resultsSSB-Indexes | ResultsPerSSB-IndexList |

OPTIONAL,

| | |
|---|---|
| resultsCSI-RS-Indexes | ResultsPerCSI-RS-IndexList |

```
OPTIONAL
    }
OPTIONAL
  },
  ...,
  [[
```

| | |
|---|---|
| cgi-Info | CGI-InfoNR |

OPTIONAL
]]
}

| | |
|---|---|
| MeasResultListEUTRA ::= | SEQUENCE (SIZE (1..maxCellReport)) OF MeasResultEUTRA |
| MeasResultEUTRA ::= | SEQUENCE { |
| eutra-PhysCellId | PhysCellId, |
| measResult | MeasQuantityResultsEUTRA, |
| cgi-Info | CGI-InfoEUTRA |

OPTIONAL,
...
}

| | |
|---|---|
| MultiBandInfoListEUTRA ::= | SEQUENCE (SIZE (1..maxMultiBands)) OF FreqBandIndicatorEUTRA |
| MeasQuantityResults ::= | SEQUENCE { |
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL
}

| | |
|---|---|
| MeasQuantityResultsEUTRA ::= | SEQUENCE { |
| rsrp | RSRP-RangeEUTRA |

OPTIONAL,

| | |
|---|---|
| rsrq | RSRQ-RangeEUTRA |

OPTIONAL,

| | |
|---|---|
| sinr | SINR-RangeEUTRA |

OPTIONAL
}

| | |
|---|---|
| ResultsPerSSB-IndexList::= | SEQUENCE (SIZE (1..maxNrofIndexesToReport2)) OF ResultsPerSSB- |

Index

| | |
|---|---|
| ResultsPerSSB-Index ::= | SEQUENCE { |
| ssb-Index | SSB-Index, |
| ssb-Results | MeasQuantityResults |

OPTIONAL
}

| | |
|---|---|
| ResultsPerCSI-RS-IndexList::= | SEQUENCE (SIZE (1..maxNrofIndexesToReport2)) OF ResultsPerCSI- |

RS-Index

| | |
|---|---|
| ResultsPerCSI-RS-Index ::= | SEQUENCE { |
| csi-RS-Index | CSI-RS-Index, |
| csi-RS-Results | MeasQuantityResults |

OPTIONAL
}
MeasResultServFreqListEUTRA-SCG ::= SEQUENCE (SIZE (1..maxNrofServingCellsEUTRA)) OF
MeasResult2EUTRA
MeasResultServFreqListNR-SCG ::= SEQUENCE (SIZE (1..maxNrofServingCells)) OF MeasResult2NR

| | |
|---|---|
| MeasResultListUTRA-FDD-r16 ::= | SEQUENCE (SIZE (1..maxCellReport)) OF MeasResultUTRA-FDD- |

r16

| | |
|---|---|
| MeasResultUTRA-FDD-r16 ::= | SEQUENCE { |
| physCellId-r16 | PhysCellIdUTRA-FDD-r16, |
| measResult-r16 | SEQUENCE { |
| utra-FDD-RSCP-r16 | INTEGER (−5..91) |

OPTIONAL,

| | |
|---|---|
| utra-FDD-EcN0-r16 | INTEGER (0..49) |

OPTIONAL
}
}

| | |
|---|---|
| MeasResultForRSSI-r16 ::= | SEQUENCE { |
| rssi-Result-r16 | RSSI-Range-r16, |
| channelOccupancy-r16 | INTEGER (0..100) |

}

| | |
|---|---|
| MeasResultCLI-r16 ::= | SEQUENCE { |
| measResultListSRS-RSRP-r16 | MeasResultListSRS-RSRP-r16 |

OPTIONAL,

| | |
|---|---|
| measResultListCLI-RSSI-r16 | MeasResultListCLI-RSSI-r16 |

OPTIONAL
}

| | |
|---|---|
| MeasResultListSRS-RSRP-r16 ::= | SEQUENCE (SIZE (1..maxCLI-Report-r16)) OF MeasResultSRS-RSRP- |

r16

| | |
|---|---|
| MeasResultSRS-RSRP-r16 ::= | SEQUENCE { |
| srs-ResourceId-r16 | SRS-ResourceId, |
| srs-RSRP-Result-r16 | SRS-RSRP-Range-r16 |

}
MeasResultListCLI-RSSI-r16 ::= SEQUENCE (SIZE (1..maxCLI-Report-r16)) OF MeasResultCLI-RSSI-r16

| | |
|---|---|
| MeasResultCLI-RSSI-r16 ::= | SEQUENCE { |
| rssi-ResourceId-r16 | RSSI-ResourceId-r16, |
| cli-RSSI-Result-r16 | CLI-RSSI-Range-r16 |

}
UL-PDCP-DelayValueResultList-r16 ::= SEQUENCE (SIZE (1..maxDRB)) OF UL-PDCP-DelayValueResult-
r16
UL-PDCP-DelayValueResult-r16 ::= SEQUENCE {

| | |
|---|---|
| drb-Id-r16 | DRB-Identity, |
| averageDelay-r16 | INTEGER (0..10000), |

...
}
UESpecificTA-r17 ::= SEQUENCE {

| | |
|---|---|
| tag-Id-r16 | TAG-Identity, |
| ueSpecificTAValue-r16 | INTEGER (0..x ), |

...
}
-- TAG-MEASRESULTS-STOP
-- ASN1STOP

In the above example, x is an integer.

TABLE 10
UESpecificTA field descriptions

tag-Id
The identity of TAG of which the reported TA is associated.
ueSpecificTAValue
The values of UE specific TA to be reported. It can have values and units
as discussed in above session or as specified in the wireless
communication standards.

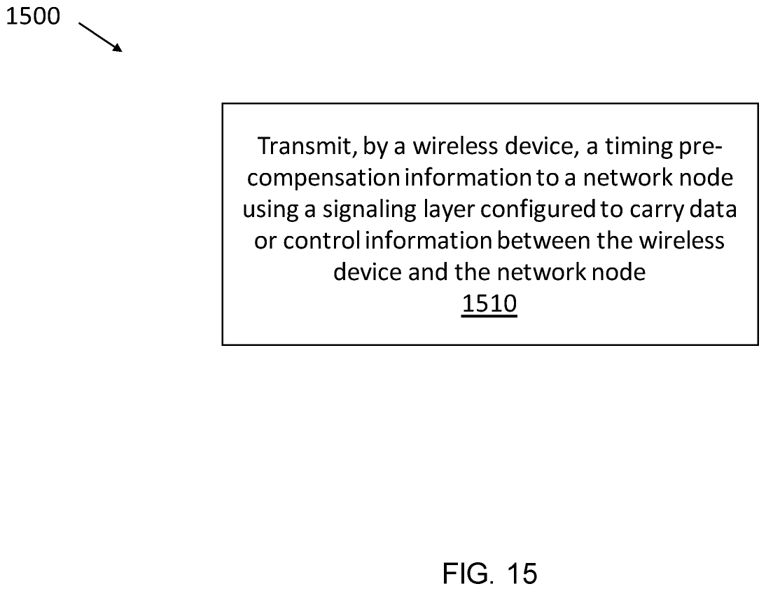

FIG. 15 shows an example of a process for wireless communication based on some example embodiments of the disclosed technology.

In some implementations, the process 1500 for wireless communication may include, at 1510, transmitting, by a wireless device, a timing pre-compensation information to a network node using a signaling layer configured to carry control information between the wireless device and the network node. In one example, the timing pre-compensation information includes timing advance information, such as UE specific timing advance (TA). In one example, the signaling layer is configured to perform a communication using a medium access control (MAC) control element (CE). In one example, the signaling layer is configured to perform a communication using a radio resource control (RRC) signaling.

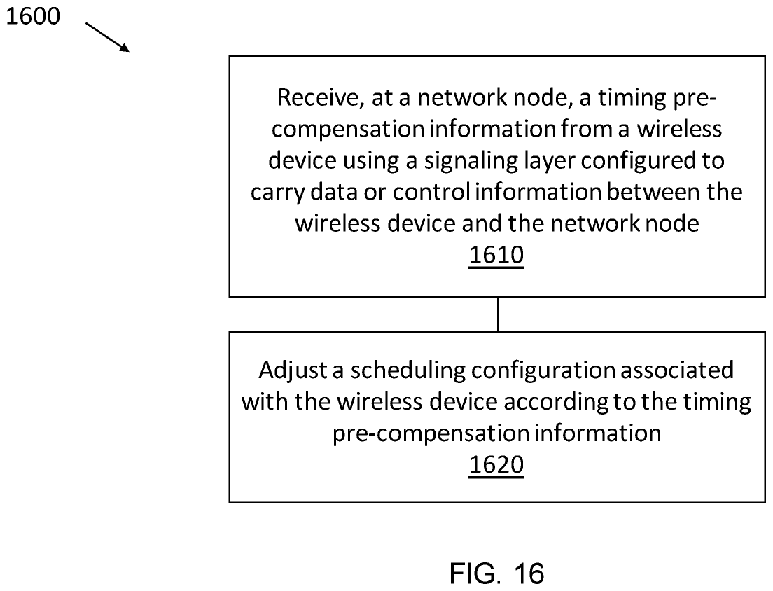

FIG. 16 shows another example of a process for wireless communication based on some example embodiments of the disclosed technology.

In some implementations, the process 1600 for wireless communication may include, at 1610, receiving, at a network node, a timing pre-compensation information from a wireless device using a signaling layer configured to carry data or control information between the wireless device and the network node, and at 1620, adjusting a scheduling configuration associated with the wireless device according to the timing pre-compensation information. In one example, the timing pre-compensation information includes timing advance information, such as UE specific timing advance (TA). In one example, the signaling layer is configured to perform a communication using a medium access control (MAC) control element (CE). In one example, the signaling layer is configured to perform a communication using a radio resource control (RRC) signaling.

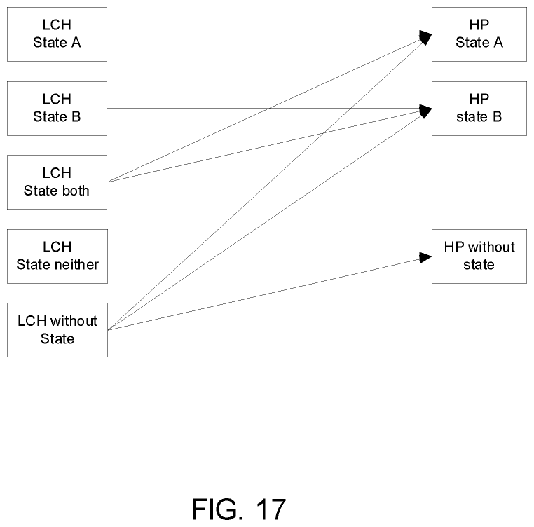

FIG. 17 shows example mapping rules between LCH and HARQ. It is to be noted that FIG. 17 shows mapping rules by way of example only, and in some implementations only one or part of the mapping rules of FIG. 17 can be supported.

For cells with large coverage and long propagation delay (e.g., NTN), different scheduling strategies can be used by NW to fulfil different service requirements. For example, NW can schedule a retransmission based on decoding results of previous scheduled transmissions, or NW can decide not to schedule any retransmission, or NW can schedule retransmission blindly (e.g., without knowing the decoding results of previous scheduled transmissions). For a finer mapping between LCH with UL grant intended for different transmission schemes, different states can be defined for HARQ process and LCH, and UE, based on the state, is configured to decide how to map between HARQ process and LCH. The possible state to be configured for LCH can be at least one of the following: {A, B, both, neither}, the possible state to be configured for HARQ process can be at least one of the following {A, B, both, neither}. Also, it is possible to not configure HARQ process and LCH without a state. In some examples, HARQ processes with/without a state and LCHs with/without a state can coexist. At least one of the following mapping rules can be used for mapping between HARQ process and LCH in LCP procedure.

For an LCH configured with state A, it can only be mapped to HARQ process configured with state A.

For an LCH configured with state B, it can only be mapped to HARQ process configured with state B.

For an LCH configured with state both, it can be mapped to HARQ process configured with either state A or state B.

For an LCH configured with state neither, it can be mapped to HARQ process not configured with either state A or state B, e.g., HARQ process not configured with a state.

For an LCH not configured with a state, it can be mapped to HARQ process configured with either state A or state B, or not configured with a state.

In some examples, above mentioned restriction (mapping rules) can be only applied for dynamic grant, or configured grant, or in both dynamic grant and configured grant.

In some examples, above mapping rules can be used in combination with one or more other LCP restrictions as defined in specs 38.321.

The state of LCH can be configured in RRC message. One example is shown as following:

### LogicalChannelConfig

The IE LogicalChannelConfig is used to configure the logical channel parameters.

TABLE 11
LogicalChannelConfig information element

```
  -- ASN1START
  -- TAG-LOGICALCHANNELCONFIG-START
```

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, kBps8, kBps16, kBps32, kBps64, kBps128, |

kBps256, kBps512,

kBps1024, kBps2048, kBps4096, kBps8192, kBps16384, kBps32768,

kBps65536, infinity},

| | |
|---|---|
| bucketSizeDuration | ENUMERATED {ms5, ms10, ms20, ms50, ms100, ms150, ms300, |

ms500, ms1000,

| | |
|---|---|
| | spare7, spare6, spare5, spare4, spare3,spare2, spare1}, |
| allowedServingCells | SEQUENCE (SIZE (1..maxNrofServingCells−1)) OF ServCellIndex |

OPTIONAL, -- Cond PDCP-CADuplication

| | |
|---|---|
| allowedSCS-List | SEQUENCE (SIZE (1..maxSCSs)) OF SubcarrierSpacing |

OPTIONAL, -- Need R

| | |
|---|---|
| maxPUSCH-Duration | ENUMERATED {ms0p02, ms0p04, ms0p0625, ms0p125, |

ms0p25, ms0p5, spare2, spare1}
OPTIONAL, -- Need R

| | |
|---|---|
| configuredGrantType1Allowed | ENUMERATED {true} |

OPTIONAL, -- Need R

| | |
|---|---|
| logicalChannelGroup | INTEGER (0..maxLCG-ID) |

OPTIONAL, -- Need R

| | |
|---|---|
| schedulingRequestID | SchedulingRequestId |

OPTIONAL, -- Need R

| | |
|---|---|
| logicalChannelSR-Mask | BOOLEAN, |
| logicalChannelSR-DelayTimerApplied | BOOLEAN, |

...,

| | |
|---|---|
| bitRateQueryProhibitTimer | ENUMERATED {s0, s0dot4, s0dot8, s1dot6, s3, s6, s12, s30} |

OPTIONAL, -- Need R
[[

| | |
|---|---|
| allowedCG-List-r16 | SEQUENCE (SIZE (0..maxNrofConfiguredGrantConfigMAC-1- |

r16)) OF ConfiguredGrantConfigIndexMAC-r16
OPTIONAL, -- Need S

| | |
|---|---|
| allowedPHY-PriorityIndex-r16 | ENUMERATED {p0, p1} |

```
OPTIONAL -- Need S
      ]],
    [[
```

| | |
|---|---|
| allowedHARQ-State | ENUMERATED {A, B, Both,neither} |

```
OPTIONAL -- Need R
  ]]
    }
OPTIONAL, -- Cond UL
    ...,
    [[
```

| | |
|---|---|
| channelAccessPriority-r16 | INTEGER (1..4) |

OPTIONAL, -- Need R

| | |
|---|---|
| bitRateMultiplier-r16 | ENUMERATED {x40, x70, x100, x200} |

```
OPTIONAL -- Need R
    ]]
  }
-- TAG-LOGICALCHANNELCONFIG-STOP
-- ASN1STOP
```

In Table 11, “allowedHARQ-State” can be allowedHARQ-DRX-LCP-Mode or a similar state or mode. The terminology used here is just an example, and thus the disclosed technology can be implemented in some embodiments to use different terminology for the same technical feature.

TABLE 12
LogicalChannelConfig field descriptions

allowedHARQ-State
This restriction applies only when the UL grant is a dynamic grant. If present, UL MAC SDUs from this logical
channel can only be mapped to dynamic grant indicating HARQ process is configured with the indicated state. A
means UL MAC SDUs from this logical channel can only be mapped to dynamic grant indicating HARQ process
configured with state A. state B means UL MAC SDUs from this logical channel can only be mapped to dynamic
grant indicating HARQ process configured with state B. Both means UL MAC SDUs from this logical channel
can be mapped to dynamic grant indicating HARQ process is configured with either state A or state B. Neither
means UL MAC SDUs from this logical channel can only be mapped to dynamic grant indicating HARQ process
is not configured with a state. If the field is not present, UL MAC SDUs from this logical channel can be mapped
to any dynamic grant configurations. Corresponds to allowedHARQ-State as specified in TS 38.321.

TABLE 13

| Conditional | |
|---|---|
| Presence | Explanation |
| UL | The field is mandatory present for a logical channel with |
| | uplink if it serves DRB. It is optionally present, Need R, |
| | for a logical channel with uplink if it serves an SRB. |
| | Otherwise it is absent. |

TABLE 14
LogicalChannelConfig information element

```
  -- ASN1START
  -- TAG-LOGICALCHANNELCONFIG-START
```

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, kBps8, kBps16, kBps32, kBps64, kBps128, |

kBps256, kBps512,

kBps1024, kBps2048, kBps4096, kBps8192, kBps16384, kBps32768,

kBps65536, infinity},

| | |
|---|---|
| bucketSizeDuration | ENUMERATED {ms5, ms10, ms20, ms50, ms100, ms150, ms300, |

ms500, ms1000,

| | |
|---|---|
| | spare7, spare6, spare5, spare4, spare3, spare2, spare1}, |
| allowedServingCells | SEQUENCE (SIZE (1..maxNrofServingCells−1)) OF ServCellIndex |

OPTIONAL, -- Cond PDCP-CADuplication

| | |
|---|---|
| allowedSCS-List | SEQUENCE (SIZE (1..maxSCSs)) OF SubcarrierSpacing |

OPTIONAL, -- Need R

| | |
|---|---|
| maxPUSCH-Duration | ENUMERATED {ms0p02, ms0p04, ms0p0625, ms0p125, |

ms0p25, ms0p5, spare2, spare1}
OPTIONAL, -- Need R

| | |
|---|---|
| configuredGrantType1Allowed | ENUMERATED {true} |

OPTIONAL, -- Need R

| | |
|---|---|
| logicalChannelGroup | INTEGER (0..maxLCG-ID) |

OPTIONAL, -- Need R

| | |
|---|---|
| schedulingRequestID | SchedulingRequestId |

OPTIONAL, -- Need R

| | |
|---|---|
| logicalChannelSR-Mask | BOOLEAN, |
| logicalChannelSR-DelayTimerApplied | BOOLEAN, |

...,

| | |
|---|---|
| bitRateQueryProhibitTimer | ENUMERATED {s0, s0dot4, s0dot8, s1dot6, s3, s6, s12, s30} |

OPTIONAL, -- Need R
[[

| | |
|---|---|
| allowedCG-List-r16 | SEQUENCE (SIZE (0..maxNrofConfiguredGrantConfigMAC-1- |

r16)) OF ConfiguredGrantConfigIndexMAC-r16
OPTIONAL, -- Need S

| | |
|---|---|
| allowedPHY-PriorityIndex-r16 | ENUMERATED {p0, p1} |

```
OPTIONAL -- Need S
      ]],
  [[
```

| | |
|---|---|
| allowedHARQ-State | ENUMERATED {A, B, Both} |

```
OPTIONAL -- Need R
  ]]
    }
OPTIONAL, -- Cond UL
    ...,
    [[
```

| | |
|---|---|
| channelAccessPriority-r16 | INTEGER (1..4) |

OPTIONAL, -- Need R

| | |
|---|---|
| bitRateMultiplier-r16 | ENUMERATED {x40, x70, x100, x200} |

```
OPTIONAL -- Need R
    ]]
  }
-- TAG-LOGICALCHANNELCONFIG-STOP
-- ASN1STOP
```

TABLE 15
LogicalChannelConfig field descriptions

allowedHARQ-State
This restriction applies only when the UL grant is a dynamic grant. If present, UL MAC SDUs from this logical
channel can only be mapped to dynamic grant indicating HARQ process is configured with the indicated state. A
means UL MAC SDUs from this logical channel can only be mapped to dynamic grant indicating HARQ process
configured with state A. state B means UL MAC SDUs from this logical channel can only be mapped to dynamic
grant indicating HARQ process configured with state B. Both means UL MAC SDUs from this logical channel
can be mapped to dynamic grant indicating HARQ process is configured with either state A or state B. If the field
is not present, UL MAC SDUs from this logical channel can be mapped to any dynamic grant configurations.
Corresponds to allowedHARQ-State as specified in TS 38.321.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (CNB), or any other device that performs as a base station.

Clause 1. A method for wireless communication, comprising: transmitting, by a wireless device, a timing pre-compensation information to a network node using a signaling layer configured to carry data or control information between the wireless device and the network node. In one example, the timing pre-compensation information includes timing advance information, such as UE specific timing advance (TA). In one example, the signaling layer is configured to perform a communication using a medium access control (MAC) control element (CE). In one example, the signaling layer is configured to perform a communication using a radio resource control (RRC) signaling.

Clause 2. The method of clause 1, further comprising performing a transmission of a random access procedure based on the timing pre-compensation information.

Clause 3. A method for wireless communication, comprising: receiving, at a network node, a timing pre-compensation information from a wireless device using a signaling layer configured to carry data or control information between the wireless device and the network node; and adjusting a scheduling configuration associated with the wireless device according to the timing pre-compensation information. In one example, the timing pre-compensation information includes timing advance information, such as UE specific timing advance (TA). In one example, the signaling layer is configured to perform a communication using a medium access control (MAC) control element (CE). In one example, the signaling layer is configured to perform a communication using a radio resource control (RRC) signaling.

Clause 4. The method of clause 3, wherein the scheduling configuration includes at least one of a timing advance or K-offset associated with the wireless device.

Clause 5. The method of any of clauses 1-4, wherein the signaling layer is configured to perform a communication using a medium access control (MAC) control element (CE),

Clause 6. The method of any of clauses 1-4, wherein the signaling layer is configured to perform a communication using a radio resource control (RRC) signaling.

Clause 7. The method of any of clauses 1-6, wherein the timing pre-compensation information is transmitted based on at least one of: a triggering event upon which the wireless device performs a transmission of the timing pre-compensation information; a reporting interval of the timing pre-compensation information; or a validity time of the scheduling configuration.

Clause 8. The method of clause 7, wherein the triggering event includes an event that a differential timing advance of the wireless device exceeds a threshold value for triggering a transmission of the timing pre-compensation information by the wireless device.

Clause 9. The method of clause 8, wherein the differential timing advance includes at least one of: a difference between a latest timing advance estimated by the wireless device and a timing advance currently being used by the wireless device; a difference between a current timing advance being used by the wireless device and the last timing advance value reported by the wireless device; or a difference between the currently used timing advance and the last timing advance used before the currently used timing advance.

Clause 10. The method of any of clauses 1-6, wherein the timing pre-compensation information is transmitted according to a request from the network node.

Clause 11. The method of clause 10, wherein the network node requests the wireless device to transmit the timing pre-compensation information by activating a serving cell.

Clause 12. The method of clause 10, wherein the network node requests the wireless device to transmit the timing pre-compensation information by using a MAC CE.

Clause 13. The method of clause 12, wherein the MAC CE is transmitted in a physical downlink shared channel (PDSCH).

Clause 14. The method of clause 12, wherein the MAC CE is identified by a logical channel identifier (LCID).

Clause 15. The method of clause 14, wherein the MAC CE includes one or more fields indicating at least one of: reserve bits, a timing advance group identifier (TAG ID) for indicating an identity of a requested timing advance group, a cell identifier (Cell ID) for indicating an identity of a requested cell; granularity information for informing the wireless device of granularity to be used for the transmission of the timing pre-compensation information; type information for informing the wireless device of a content type requested by the network node; Cell i field for informing the wireless device of a serving cell associated with the timing pre-compensation information; or TAG i field for informing the wireless device of a TAG group associated with the timing pre-compensation information.

Clause 16. The method of any of clauses 10-15, wherein the network node instructs, using downlink control information (DCI), the wireless device to transmit the timing pre-compensation information.

Clause 17. The method of clause 16, wherein the using of the DCI includes initiating the timing advance report by using a physical downlink control channel (PDCCH) order to cause to the wireless device to initiate the random access procedure.

Clause 18. The method of clause 17, wherein the using of the DCI includes initiating the transmission of the timing pre-compensation information by: receiving a physical downlink control channel (PDCCH) order; comparing a preamble reserved for the transmission of the timing pre-compensation information with a preamble corresponding to the PDCCH order; and initiating a random access procedure upon determination that the preamble corresponding to the PDCCH order matches the preamble reserved for the transmission of the timing pre-compensation information.

Clause 19. The method of any of clauses 1-18, wherein the timing pre-compensation information includes at least one of timing advance related information or location related information.

Clause 20. The method of clause 19, wherein the timing advance related information includes at least one of: a total timing advance applied to the wireless device including the wireless device estimated timing advance and the network node adjusted timing advance; the wireless device estimated timing advance; a difference between the latest timing advance estimated by the wireless device and the timing advance currently being used by the wireless device, a delta TA indicating difference between the current timing advance being used by the wireless device and the last timing advance reported by the wireless device, or a difference between the timing advance currently being used by the wireless device and the last timing advance used before the currently used timing advance.

Clause 21. The method of clause 20, wherein the timing pre-compensation information is carried in an MAC CE transmitted in a physical uplink shared channel (PUSCH) identified by an LCID.

Clause 22. The method of clause 21, wherein the MAC CE includes at least one MAC CE of a fixed size.

Clause 23. The method of clause 21, wherein the MAC CE includes at least one MAC CE of a variable size.

Clause 24. The method of clause 21, wherein the MAC CE includes at least one MAC CE of a fixed size and at least one MAC CE of a variable size.

Clause 25. The method of any of clauses 21-24, wherein the MAC CE includes one or more fields indicating at least one of: the wireless device specific timing advance (TA) for indicating values of TA to be reported by the wireless device; a length of the MAC CE; reserved bits; a timing advance group identifier (TAG ID) for indicating an identity of a requested timing advance group, a cell identifier (Cell ID) for indicating an identity of a requested cell; a type of the MAC CE.

Clause 26. The method of clause 25, wherein, in a case that the type of the MAC CE has a first value to indicate that the MAC CE has a variable size, the field indicating the length field of the MAC CE indicates the length of the MAC CE to be reported.

Clause 27. The method of clause 25, wherein, in a case that the type of the MAC CE has a second value to indicate that the MAC CE has a fixed size, the field indicating the length of the MAC CE is set as reserved.

Clause 28. An apparatus for wireless communication comprising a processor that is configured to carry out the method of any of clauses 1 to 27.

Clause 29. A non-transitory computer readable medium having code stored thereon, the code when executed by a processor, causing the processor to implement a method recited in any of clauses 1 to 27.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method for wireless communication, comprising:
transmitting, by a wireless device, to a network node, a first information including a timing advance (TA) of the wireless device using a signaling layer configured to carry data or control information between the wireless device and the network node,
wherein the first information is transmitted based on a triggering event upon which the wireless device performs a transmission of the first information,
wherein the TA is transmitted using a medium access control (MAC) control element (CE).

2-4. (canceled)

5. The method of claim 1, wherein the signaling layer is configured to perform a communication using a medium access control (MAC) control element (CE).

6-7. (canceled)

8. The method of claim 1, wherein the triggering event includes an event that a differential timing advance of the wireless device exceeds a threshold value for triggering a transmission of the first information by the wireless device.

9. The method of claim 8, wherein the differential timing advance includes a difference between a current timing advance being used by the wireless device and a last timing advance value reported by the wireless device.

10-13. (canceled)

14. The method of claim 1, wherein the MAC CE is identified by a logical channel identifier (LCID) of a logical channel (LCH).

15-29. (canceled)

30. The method of claim 1, wherein the MAC CE has a priority below a cell radio network temporary identifier (C-RNTI) MAC CE or uplink (UL)-common control channel (CCCH) data in a logical channel prioritization procedure.

31. The method of claim 1, wherein the MAC CE is octet-aligned.

32. The method of claim 1, wherein the MAC CE is fixed-sized.

33. The method of claim 1, wherein, upon transmitting the first information including the TA, the MAC CE includes reserved bits set as zero and the TA.

34. The method of claim 33, wherein the TA is reported using units at slot level.

35. The method of claim 1, further comprising:
generating, by the wireless device, data related to the TA in a case that there is an available uplink (UL) resource; or
triggering, by the wireless device, a scheduling request (SR) procedure to request a resource for reporting the TA in a case that there is no available UL resource.

36. A method for wireless communication, comprising:
receiving, at a network node, from a wireless device, a first information including a timing advance (TA) of the wireless device using a signaling layer configured to carry data or control information between the wireless device and the network node; and
wherein the first information is transmitted based on a triggering event upon which the wireless device performs a transmission of the first information,
wherein the TA is transmitted using a medium access control (MAC) control element (CE).

37. The method of claim 36, wherein the signaling layer is configured to perform a communication using a medium access control (MAC) control element (CE).

38. The method of claim 36, wherein the triggering event includes an event that a differential timing advance of the wireless device exceeds a threshold value for triggering a transmission of the first information by the wireless device.

39. The method of claim 38, wherein the differential timing advance includes a difference between a current timing advance being used by the wireless device and a last timing advance value reported by the wireless device.

40. The method of claim 36, wherein the MAC CE is identified by a logical channel identifier (LCID) of a logical channel (LCH).

41. The method of claim 36, wherein the MAC CE has a priority below a cell radio network temporary identifier (C-RNTI) MAC CE or uplink (UL)-common control channel (CCCH) data in a logical channel prioritization procedure.

42. The method of claim 36, wherein the MAC CE is octet-aligned.

43. The method of claim 36, wherein the MAC CE is fixed-sized.

44. The method of claim 36, wherein, upon transmitting the first information including the TA, the MAC CE includes reserved bits set as zero and the TA, wherein the TA is reported using units at slot level.
